(19) United States
(12) Patent Application Publication
(10) Pub. No.: US 2015/0020087 A1
(43) Pub. Date: Jan. 15, 2015

(54) System for Identifying Features in a Television Signal

(71) Applicants: Anthony Rose, London (GB); Adrian Spender, London (GB); Matthew Galloway, London (GB); Michael Slater, London (GB)

(72) Inventors: Anthony Rose, London (GB); Adrian Spender, London (GB); Matthew Galloway, London (GB); Michael Slater, London (GB)

(21) Appl. No.: 13/938,802

(22) Filed: Jul. 10, 2013

(51) Int. Cl. H04N 21/8405; H04N 21/442

(52) U.S. Cl. CPC H04N 21/8405; H04N 21/442
USPC 725/20

(57) ABSTRACT

A computer system is disclosed in which features can be identified in a live television signal. A keyword extractor is arranged to identify keywords in the received television signal or to identify characteristic features in the signal. A content retrieval unit can then retrieve additional content that is related to selected keywords. An output unit can output keywords initially in an expanded format which may include the keyword and the retrieved additional content. The keywords are then displayed in a contracted format after a predetermined period of time has elapsed in order to make space on for newer keywords in the expanded format.

### FIELD OF THE INVENTION

This invention relates to a computer system and a corresponding method for identifying features in a television signal.

### BACKGROUND OF THE INVENTION

A number of known systems exist for identifying keywords in live television. Our co-pending U.S. patent application Ser. Nos. 13/424,084, 13/424,068 and 13/424,038 describe a keyword extractor that can extract keywords from a live television feed using subtitles or voice recognition software. The extracted keywords can be displayed on a user display device to provide a context for live television. Typically keywords can be displayed with a click-through universal resource locator (URL) so that a user can select the keyword and be directed to a web page that provides related information or content. This system can allow users to engage with live television content and to find out further information about keywords that trigger their interest.

In known systems a list of keywords is typically shown on a user display device which may be a personal computer, tablet device, personal digital assistant (PDA) or smartphone. Some of these devices have small screens and real-estate on the screen is valuable and must be carefully allocated. An object of the present invention is to provide a system and method for optimising the display of keywords on a user device.

### SUMMARY OF THE INVENTION

In known systems a list of keywords is typically shown on a user display device which may be a personal computer, tablet device, personal digital assistant (PDA) or smartphone. Some of these devices have small screens and real-estate on the screen is valuable and must be carefully allocated. An object of the present invention is to provide a system and method for optimising the display of keywords on a user device.

According to the present invention there is provided a computer system for identifying features in television comprising: a receiver configured to receive a television signal; and one or more processors configured to identify features in the received television signal that can be associated with respective graphical tags, and to output the associated graphical tags for display on a user device, wherein the associated graphical tags can be output in a first format and a second format, wherein the first format occupies a larger area on a display screen of the user device than the second format, and wherein the one or more processors are configured to output graphical tags in the first format and to modify the graphical tags so that they are in the second format when a predetermined condition is satisfied.

In this way the system can identify features in a live television signal and display associated graphical tags or indicators on a user device such as a television, computer or tablet device. Selected or special tags can be shown in a first, expanded format which may include additional content such as a photograph, embedded video and/or brief textual description. The expanded format can be collapsed to the second format when the predetermined condition is satisfied.

A tag may be of most interest to a user when it first appears. This is partly because fresh tags are the most closely connected with current television content. In addition, a user's interest is most likely to be triggered on first sight of tag. By initially showing tags in the first (expanded) format it is possible to display additional content that may help to trigger a user's interest in the keyword. Older tags may be of less interest to users. Therefore, tags can be displayed in the second, contracted form once the predetermined condition has been satisfied. This is desirable because tags occupy a larger area on a display screen when they are shown in the first format. Therefore, a balance can be achieved between the number of tags that can be displayed and the number of tags that can be displayed in the first format. This optimises the use of real-estate space on a user display device.

The graphical tags are preferably displayed as keywords, wherein the keyword is related to the identified feature in television. In this arrangement the keyword may be displayed in a first format including the keyword and including additional content that is related to the keyword. The second format preferably includes less content so that it can be displayed in a smaller area; in one arrangement the second format includes the keyword only.

Alternatively, or in addition, the graphical tags may also be displayed as images, video files or any other indicator that is related to the identified television feature. In one example the identified feature of television may be an advertisement for a car. The graphical tag may be displayed in the first format as an image of the car. The graphical tag may be displayed with only the name of the car in the second format so that it occupies a smaller area on a user's display device. In both formats the graphical tag may include a hyperlink that, when selected, will direct a user to a webpage with more information about the car.

In one arrangement the graphical tag may be displayed as a keyword together with additional content that may be at least one of: text, an image, an embedded video file and an embedded audio file. In one example the keyword may be the name of a film star. In these circumstances the additional content may include one of a photograph of the film star, a biography, and an embedded video of the trailer to their latest movie. This additional content may trigger the user's interest and cause them to select the keyword and find out further information. In a preferred arrangement the second format of the keyword includes the text of the keyword and a hyperlink that would direct the user to further content if selected.

The graphical tags may be output for display in a chronological sequence. The most recent tags in the sequence are likely to correspond to the subject of live television, and preferably these tags are emphasised since they are most likely to be of interest to users.

In one example the predetermined condition may be the expiry of a predetermined period of time from the identification of the relevant feature or tag. Thus, tags may be displayed in the first format for a fixed time period after which they can be displayed in the second format.

In another example the predetermined condition may be the output of a new tag in the first format. In this way, only a predetermined number of tags may be displayed in the first format at any time. This may optimise space on the user device display screen. By displaying a limited number of tags in the first format space may be provided for additional tags in the second format.

In a further example the predetermined condition may be dependent on properties of the tag and/or the additional content. For example, the predetermined condition may be a time period that is dependent on a property of the tag such as its popularity, or the duration of an associated segment of television. Taking one example, the content may be an embedded video file and the tag may be displayed for a period of time that is proportional to the number of views of the video. In this example tags may be displayed for longer periods of time if they are more likely to be of interest to a user. In another example, the tag may be associated with an advertisement that is played on television. The tag may be output in the first format while the advertisement is playing and then it may be modified and displayed in the second format once the advertisement ends.

In some examples the time period may also depend on properties of the user, including their known preferences. For example, it may be known that the user ‘likes’ a certain film star, based on their previous behaviour. In these circumstances a tag associated with this film star may be displayed in the first format for a longer period of time.

Words may be detected directly in a television signal using subtitles or automatic speech recognition. Keywords are preferably a subset of all detected words. The keywords may be selected based on frequency of use or if they match items in a dictionary of keywords.

In addition, the one or more processors may be configured to identify segments of television by detecting a characteristic feature in the received television signal. For example, the processors may use audio and/or video fingerprinting to recognise a particular segment of television such as an advertisement, a channel “ident” or the introductory or closing sequence to a program. The identified segment of television may be associated with one or more tags based on rules of association. For example, an advertisement may be associated with the name/image of the product and/or brand being advertised. The introductory or closing sequence to a program may be associated with the name of the show or its sponsor. A channel “ident” may be associated with the name of the channel or one of its sponsors.

Preferably the one or more processors are configured to select a subset of special tags which may be displayed initially in the first format and then modified to be displayed in the second format. Other tags may be displayed directly in the second format. This gives enhanced prominence to certain, special tags.

Preferably special tags are selected according to the technique used to identify the features in the television stream. More specifically, special tags may be those that are identified by matching a feature in the received television signal with a characteristic stored feature. In this way special tags may be given an enhanced prominence in comparison to tags detected directly using other techniques such as subtitle extraction or speech recognition. This can provide enhanced prominence to tags that are associated with advertisements or sponsors.

As an alternative, or in addition, the one or more processors may be configured to select tags on the basis of tag properties. In one example the popularity of tags may be used to determine tags to select. Thus, popular or trending tags can be identified and selected for initial display in the first format. This can allow users to have access to further information in respect of popular tags, or tags that are the topic of current discussion. In another example the one or more processors may be configured to select tags on the basis of user preferences. The user's known preferences can be used to select tags of most interest and to display these in the first format.

Preferably the computer system includes a display device for receiving and displaying the tags output by the output unit. In just some examples the display device may be part of a television, a smart-phone, a tablet computer, a personal digital assistant (PDA) or a personal computer. Preferably the display device is auxiliary to a television that plays the corresponding video and audio signals.

The one or more processors may be configured to output identified but non-selected tags in the second format. Tags of less importance can therefore be displayed immediately in the second format. These tags may be of interest to the user because they are directly related to the live television content. However, they can be displayed directly in a smaller format in order to conserve real-estate space on the user display device.

According to another aspect of the present invention there is provided a method of identifying features in a television signal comprising the steps of: receiving a television signal; identifying features in the received television signal that can be associated with respective graphical tags; outputting the associated graphical tags for display on a user device, wherein the associated graphical tags can be displayed in a first format and a second format, wherein the first format occupies a larger area on a display screen of the user device than the second format, and wherein the graphical tags are output initially in the first format; and modifying the graphical tags in the first format so that they are displayed in the second format when a predetermined condition is satisfied.

According to yet another aspect of the present invention there is provided a non-transitory computer readable storage medium having a computer program stored thereon, the computer program comprising processor readable instructions that, when executed, direct a device to perform actions comprising: receiving a television signal; identifying features in the received television signal that can be associated with respective graphical tags; outputting the associated graphical tags for display on a user device, wherein the associated graphical tags can be displayed in a first format and a second format, wherein the first format occupies a larger area on a display screen of the user device than the second format, and wherein the graphical tags are output initially in the first format; and modifying the graphical tags in the first format so that they are displayed in the second format when a predetermined condition is satisfied.

Apparatus features may be provided as corresponding method features and vice-versa.

### BRIEF DESCRIPTION OF THE DRAWINGS

Embodiments of the present invention will now be described, by way of example only, with reference to the accompanying drawings in which:

FIG. 1 is a schematic view of client and server devices in a network in an embodiment of the present invention;

FIG. 2 is a schematic view of the components in a server device in an embodiment of the present invention;

FIG. 3 is a flow diagram showing a sequence of steps that can be performed in a an embodiment of the present invention; and

FIGS. 4A and 4B are screenshots in an embodiment of the invention showing extracted keywords on a user display device.

### DETAILED DESCRIPTION OF THE INVENTION

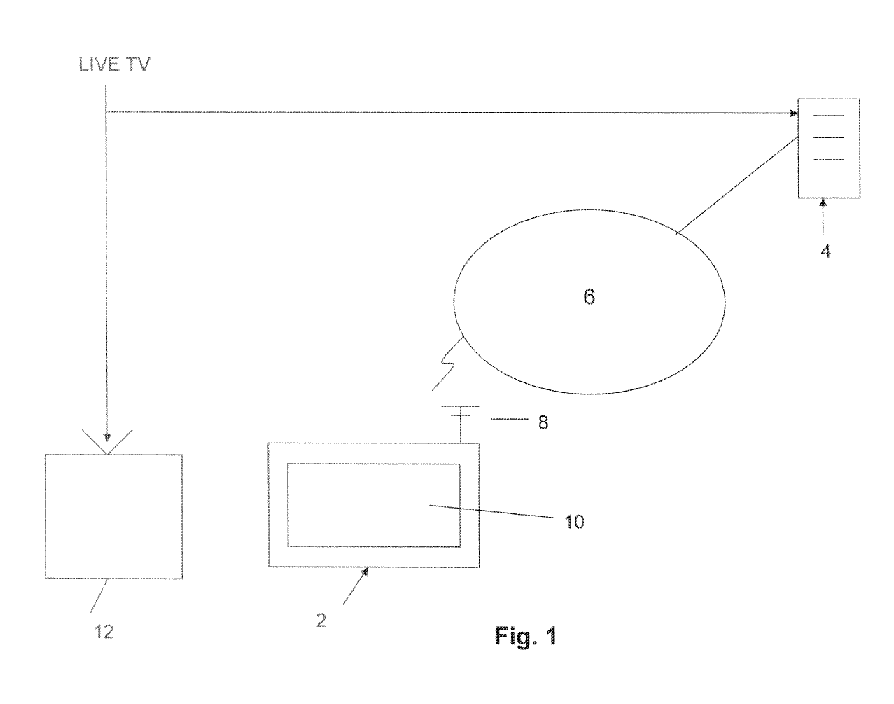

FIG. 1 is a schematic view of a client device 2 and a server computer 4 in communication over a network 6 such as the internet. A television 12 is also provided, and both the television 12 and the server computer 4 are configured to receive a live television signal.

The client device 2 includes an aerial 8 or other communication means for use in transmitting and receiving data over the network 6. The client device 2 also includes a screen 10 that can be used both for displaying content and for receiving user inputs. In this embodiment the client device 2 is separate from the television 12, and it may be configured as a remote control, a personal computer, a tablet computer, a smart-phone or a personal digital assistant (PDA). In an alternative arrangement the client device 2 could be integrated together with the television 12.

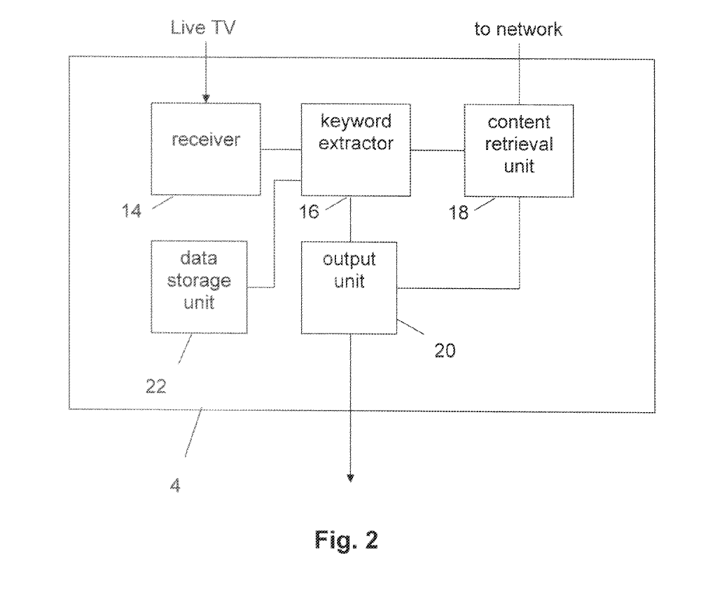

Further detail of the server device 4 is provided in FIG. 2. The server device 4 includes a receiver 14 that is configured to receive the live television signal. A feature extractor 16 is arranged to analyse subtitles in the live television signal and can identify keywords that match terms in a dictionary stored in a data storage unit 22. The feature extractor 16 is also arranged to identify segments of television by matching a profile in the live television signal with characteristic stored profiles in the data storage unit 22. In this way, the feature extractor 16 can use audio and/or video “fingerprinting” to identify known segments of television such as advertisements, television program start or end sequences or channel “idents”. Each known segment of television is associated with one or more graphical tags in the data storage unit 22. For example, an advertisement may be associated with the name of the product or brand being advertised and/or an image associated with that brand. A content retrieval unit 18 is configured to retrieve content from the internet 6 that is related to selected keywords that are identified directly or indirectly by the feature extractor 16. Finally, an output unit 20 is provided for outputting keywords for display on a user device 2. The receiver 14, feature extractor 16, content retrieval unit 18 and output unit 20 may be provided as modules in one or more processors.

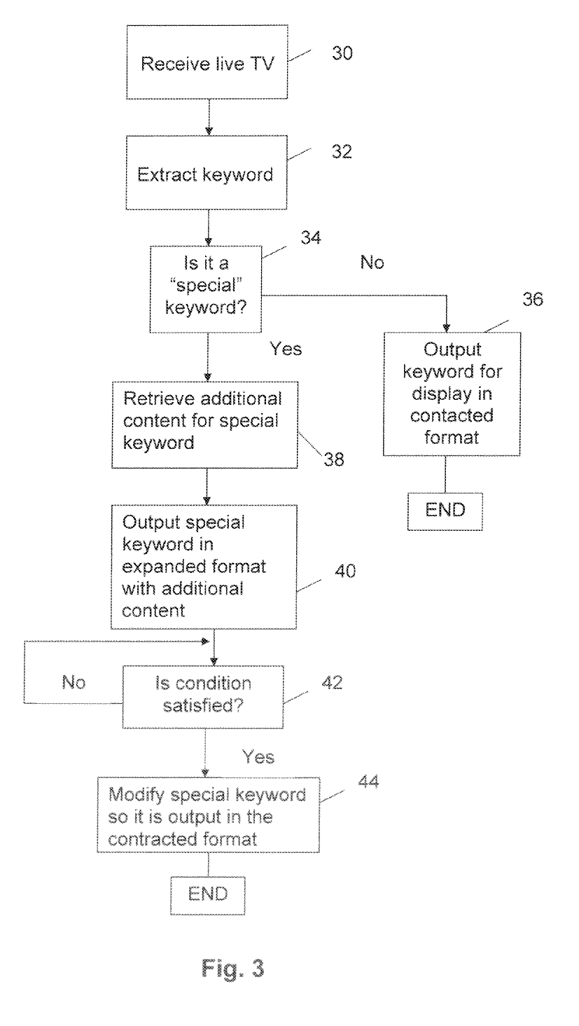

The operation of the invention will now be described with reference to the flow diagram shown in FIG. 3 which shows the treatment of each feature of television identified by the feature extractor 16. At step 30 the receiver 14 receives a live television signal via broadcast, cable, network connection or other means. At step 32 the feature extractor 16 is configured to analyse subtitles in the live television signal and to match the extracted words with a dictionary of keywords stored in the data storage unit 22. In addition, the feature extractor 16 is configured to analyse an audio or video signal in the received signal and match this with stored signals in the data storage unit 22 that are characteristic of known segments of television. Where a match is identified the feature extractor 16 is configured to extract one or more keywords associated with the known segment of television from the data storage unit 22.

Preferably each keyword is stored in the data storage unit 22 together with an associated hyperlink. In certain instances a keywords may actually be composed of more than one word (for example the name of an individual such as “Tom Cruise” may be stored as a keyword).

At step 34 the feature extractor 16 analyses whether each keyword is one of a subset of special keywords in the dictionary. The special or selected keywords typically include only the most popular keywords and/or keywords that are currently trending. The special or selected keywords may be static and determined by an administrator in advance. Alternatively the special or selected keywords may be chosen based on dynamic factors including current internet trends. In another configuration, at step 34, the special or selected keywords may be those that have been identified by matching an audio or video signal in the received signal with a characteristic stored signal in the data storage unit 22.

At step 36 the output unit 20 is configured to output any ordinary keywords that are extracted by the feature extractor 16. These keywords are output in a contracted format, typically including only the text of the keyword and an embedded hyperlink. In the contracted format keywords only occupy a small area of the display screen 10 on the user device 2. Keywords are typically displayed in a chronological list, and old keywords are shifted from the bottom of the list when new keywords appear at the top.

At step 38 the content retrieval unit 18 is configured to retrieve additional content for the special or selected keywords. The content retrieval unit 18 is connected to the internet 6 and can retrieve content that is associated with the relevant keyword, possibly including images, videos, advertisements and/or text documents. In an alternative embodiment the content retrieval unit 18 may retrieve the additional content directly from the data storage unit 18; this may be appropriate where the additional content is determined in advance for each special or selected keyword.

At step 40 the output unit 20 is configured to output the special or selected keywords in an expanded format including the text of the keyword, an embedded hyperlink and the additional content retrieved by the content retrieval unit 18. Thus, selected keywords of greater importance may be displayed initially in an expanded format together with the additional content. This may trigger the user's interest in the keyword and prompt them to select the additional content and find out further information.

At step 42 the output unit 18 is configured to query whether a predetermined condition has been satisfied. In certain embodiments the predetermined condition may be expiry of a predetermined period of time from identification of the keyword. If the predetermined condition is satisfied then, at step 44, the selected keyword is modified so that it is shown in the contracted form, including only the text of the keyword and an embedded hyperlink.

Thus, selected keywords can be displayed initially in the expanded format together with additional content. These expanded keywords are therefore displayed with an enhanced prominence on the display screen 10 of a user device 2. The area occupied by the selected keywords is then reduced and they are shown in the contracted format. In order to conserve space on the display screen 10 the selected keywords are modified so that they are displayed in the contracted form. The contracted keywords are still available for selection by a user, but space can be freed on the display screen 10 so that other keywords can be displayed in the expanded format.

The example above describes the invention in the context of keywords that can be displayed on the display screen 10 of the user device 2. It will be appreciated that a variety of alternative graphical tags may be displayed on the display screen 10. For example, the graphical tag may be displayed as image together with a hyperlink. The image may be displayed initially in an expanded format and subsequently in a contracted format when a predetermined time period has elapsed.

In the example above the predetermined condition is the expiry of a predetermined time period from the identification of the keyword. Another predetermined condition may be the identification of a new special keyword. In this example a special keyword can be displayed initially in expanded format and can then be displayed in a contracted form to make space for a newly identified special keyword.

In a further example the predetermined condition may be the expiry of a time period that is related to an identified segment of television. Thus, if the relevant keyword has been identified by matching a received audio or video signal with a characteristic stored signal, the keyword may be displayed in the expanded format for a period of time that is related to the duration of the relevant television segment. For example, the characteristic stored signal may be related to a television advertisement or the starting sequence of a television program. The keyword can therefore be displayed in its expanded format for a period of time that matches the length of the advertisement or starting sequence. After this the keyword can collapse to the contracted format, since it is less likely to interest a user when live television has moved on to another topic.

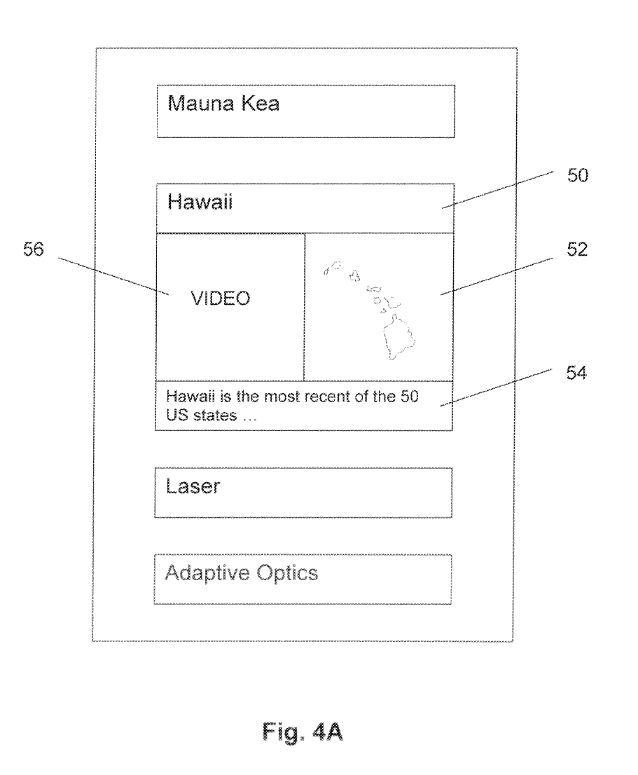

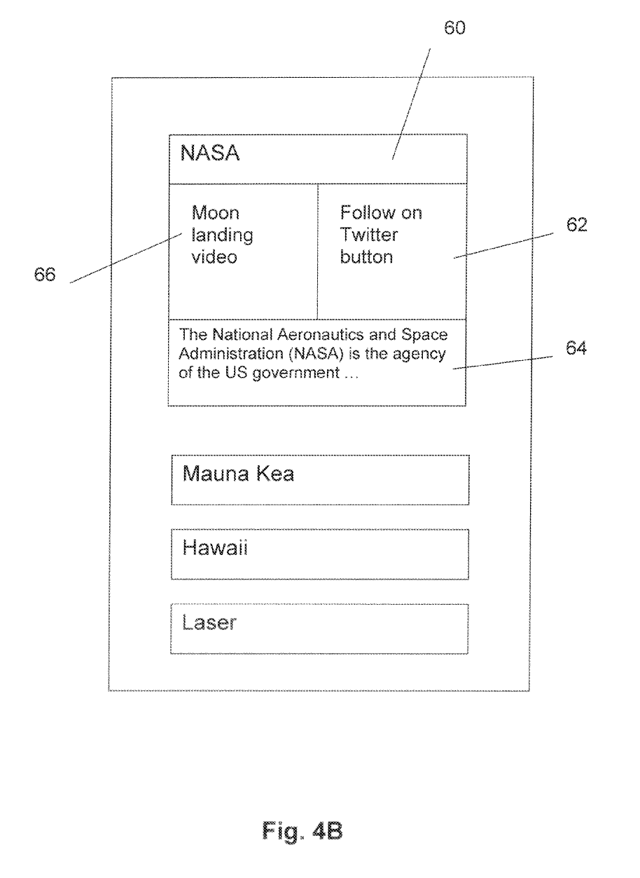

FIG. 4A is an example screenshot of a display panel on the screen 10 of the user display device 2. The display panel shows a chronological list of keywords identified by the server computer 4 in live television (in this example the live television is a documentary on astronomy). A number of ordinary keywords are identified by the feature extractor 16 and these are output by the output unit 20 directly in a contracted format. In FIG. 4A this includes the keywords “Adaptive Optics”, “Laser” and “Mauna Kea” which are detected by the feature extractor 16 directly in a subtitle feed. The keyword for “Hawaii” in this example is a special keyword, and it is detected differently.

The keyword “Hawaii” is identified when an advertisement for a Hawaii tourist authority is played in live television. The advertisement is detected by the feature extractor 16 by matching an aspect of the video signal in the received television signal with a characteristic video signal for the known advertisement stored in the data storage unit 22. The relevant advertisement is associated with the keyword “Hawaii”, according to rules stored in the data storage unit 22. The keyword “Hawaii” is rendered special in this example by virtue of the identification process, using video fingerprinting. Additional content is retrieved for the special keyword “Hawaii” by the content retrieval unit 18. On the other hand, only a hyperlink is retrieved from the data storage unit 22 for the conventional keywords: “Adaptive Optics”, “Laser” and “Mauna Kea”.

The special keyword “Hawaii” is then displayed along with the retrieved additional content, as shown in FIG. 4A. In this example the keyword “Hawaii” is displayed in a first area 50 together with an embedded URL which would take the user to a web page about Hawaii. The additional content includes an image 52 showing a map of the islands, a short description 54 and a promotional video 56 from the tourist authority. The conventional keywords are displayed in a contracted format with an embedded hyperlink; these keywords can be selected by a user, if desired, in order to access additional information.

FIG. 4B is an example screenshot showing the display panel of FIG. 4A at a later time. In this example a new keyword has been identified for “NASA”. This keyword is identified by the feature extractor 16, directly in the television subtitles. “NASA” in this example also corresponds to a special or selected keyword. The keyword is rendered special in this example according to rules stored in the data storage unit 22, rather than according to its method of identification. Additional content is retrieved for the keyword “NASA” by the content retrieval unit 18 so that the keyword can be displayed along with the additional content.

As shown in FIG. 4B, the keyword “NASA” is displayed in a first area 60 together with an embedded URL which would take the user to a web page about NASA®. The additional content includes a link 62 to follow NASA® on twitter®, a short description 64 and a video 66 showing the moon landings. In this example the output unit 20 is arranged to collapse the old keyword for “Hawaii” in order to free space for the new expanded keyword for “NASA”. Thus, “Hawaii” is shown as a contracted keyword in FIG. 4B including only text and an embedded URL hyperlink. The old keyword for “Adaptive Optics” is also shifted off the display panel in order to make space for the newly identified keyword.

In the example above the keyword for “Hawaii” is collapsed from its expanded form to its contracted form upon output of the keyword “NASA” in an expanded form. In alternative arrangements different criteria may be used for collapsing the expanded keyword for “Hawaii”. For example, the output unit 20 may be configured to collapse the keyword after a predetermined time period has elapsed. The expanded keyword may be shown for around 10 seconds and then collapsed so that expanded keywords relate to the most recent television content. In another arrangement the time period may depend on properties of the keyword and/or the additional content. For example, if the additional content includes an embedded video file then the keyword may be displayed in the expanded form for a period of time that is proportional to the number of views of the video. In yet another example the time period may depend on the duration of the relevant advertisement from the Hawaii tourist authority, and the keyword may be collapsed to its contracted form at the same time as the advertisement ends.

The criteria for collapsing the expanded keyword may also depend on properties of the user. In one example, it may be known that the user ‘likes’ a certain keyword, based, for example, on their internet search history. In these circumstances the relevant keyword may be displayed in its expanded format for a longer period of time.

What is claimed is:

1. A computer system for identifying features in television comprising:
a receiver configured to receive a television signal; and
one or more processors configured to identify features in the received television signal that can be associated with respective graphical tags, and to output the associated graphical tags for display on a user device, wherein the associated graphical tags can be output in a first format and a second format, wherein the first format occupies a larger area on a display screen of the user device than the second format, and wherein the one or more processors are configured to output graphical tags in the first format and to modify the graphical tags so that they are in the second format when a predetermined condition is satisfied.

2. The computer system of claim 1 wherein the graphical tags includes one or more keywords.

3. The computer system of claim 1 wherein content the graphical tags include content in the first format that is not provided in the second format.

4. The computer system of claim 3 wherein the content is at least one of: text, an image an embedded video file and an embedded audio file.

5. The computer system of claim 1 wherein the graphical tags are output for display in a chronological sequence.

6. The computer system of claim 1 wherein the predetermined condition is the expiry of a predetermined period of time from the identification of the feature corresponding to the graphical tag.

7. The computer system of claim 1 wherein the predetermined condition is the output of a new graphical tag in the first format.

8. The computer system of claim 1 wherein the predetermined condition is dependent on properties of the graphical tag and/or the identified feature in the television signal.

9. The computer system of claim 1 wherein the predetermined condition is the expiry of a time period that is dependent on the duration of a segment of television associated with the graphical tag.

10. The computer system of claim 1 wherein the one or more processors are configured to select a subset of graphical tags that can be displayed initially in the first format and subsequently in the second format, upon satisfaction of the predetermined condition.

11. The computer system of claim 10 wherein graphical tags that are not in the selected subset are displayed directly in the second format.

12. The computer system of claim 10 wherein graphical tags in the subset are selected based on the technique used to identify the feature in the television signal.

13. The computer system of claim 12 wherein the one or more processors are configured to identify a known segment of television by matching an aspect of the received television signal with a stored aspect of the known segment, wherein the known segment of television is associated with a graphical tags, and wherein graphical tags in the subset are selected if they are identified in this way.

14. The computer system of claim 10 wherein the keywords in the subset are selected on the basis of keyword properties.

15. The computer system of claim 10 wherein the keywords in the subset are selected on the basis of user preferences.

16. The computer system of claim 1 wherein the one or more processors are configured to identify keywords directly in the live television signal.

17. The computer system of claim 1 wherein the one or more processors are configured to identify a known segment of television by matching an aspect of the received television signal with a stored aspect of the known segment, wherein the known segment of television is associated with a graphical tag.

18. The computer system of claim 1 further comprising a display device for receiving and displaying the graphical tags.

19. A method of identifying features in a television signal comprising the steps of:
receiving a television signal;
identifying features in the received television signal that can be associated with respective graphical tags;
outputting the associated graphical tags for display on a user device, wherein the associated graphical tags can be displayed in a first format and a second format, wherein the first format occupies a larger area on a display screen of the user device than the second format, and wherein the graphical tags are output initially in the first format; and
modifying the graphical tags in the first format so that they are displayed in the second format when a predetermined condition is satisfied.

20. A non-transitory computer readable storage medium having a computer program stored thereon, the computer program comprising processor readable instructions that, when executed, direct a device to perform actions comprising:
receiving a television signal;
identifying features in the received television signal that can be associated with respective graphical tags;
outputting the associated graphical tags for display on a user device, wherein the associated graphical tags can be displayed in a first format and a second format, wherein the first format occupies a larger area on a display screen of the user device than the second format, and wherein the graphical tags are output initially in the first format; and
modifying the graphical tags in the first format so that they are displayed in the second format when a predetermined condition is satisfied.

21. A computer system for identifying features in television comprising:
a receiver configured to receive a television signal; and
one or more processors configured to identify features in the received television signal that can be associated with keywords, to retrieve additional content related to the identified features and to output the associated keywords for display on a user device,
wherein the keywords can be output in a first format and a second format, the first format including the keyword and the retrieved additional content, and the second format including the keyword, and wherein the one or more processors are configured to output the keywords in the first format and to modify the keywords so that they are in the second format when a predetermined condition is satisfied.
